(19) United States
(12) Patent Application Publication
(10) Pub. No.: US 2020/0138003 A1
(43) Pub. Date: May 7, 2020

(54) FLY TRAP

(71) Applicant: Stephen P. Shoemaker, JR., Redondo Beach, CA (US)

(72) Inventor: Stephen P. Shoemaker, JR., Redondo Beach, CA (US)

(21) Appl. No.: 16/178,401

(22) Filed: Nov. 1, 2018

(51) Int. Cl. A01M 1/14; A01M 1/16; A01M 1/10; G09F 13/00; G09F 13/04; G09F 23/06

(52) U.S. Cl. CPC A01M 1/145; A01M 1/16; G09F 23/06; G09F 13/005; G09F 13/0413; A01M 1/106

(57) ABSTRACT

An improved fly trap in the form of a sign that can attract and trap flies before they enter an establishment or once the flies are inside of an establishment. The fly trap uses an attractive element in the form of a plurality of LED lights, preferably blue LED lights, to coax flies to enter the sign. Adjacent the LED lights is a roller on which adhesive paper, or fly paper, is mounted. Flies that land on the fly paper are captured, and when the paper is full or need to be changed, the roller is actuated to present fresh fly paper.

### BACKGROUND

Flies have been a major nuisance to humans and animals for thousands of years. Many transmit disease causing organisms and are linked directly to typhoid, cholera, dysentery, diarrhea, pinworms, roundworms, whipworms, hookworms and tapeworms. Most flies have filthy habits that make them efficient disease transmitters. Disease causing organisms are picked up by flies from garbage, sewage, rotting debris, dead animal carcasses, animal excrement, etc. and are directly transmitted to surfaces such as food and our food preparation surfaces. This is a particular concern for restaurants and certain retail establishments.

During the summer and fall months, controlling flies can be a never ending task. Any flying insect can travel hundreds of feet or yards, even miles in some cases away from their breeding areas. Caught up in a wind current, flies can literally travel the from region to region or State to State in some cases. This is why taking a few extra precautions against flies can save stores and restaurants from a big fly headache down the road.

Prevention concerns how to inhibit flies from entering a business or home, Treatment strategies focus on reducing the attraction if at possible. For example, elimination of odors that attract flies is one way to control flies. Making sure that doors and windows are screened and sealed is another way to reduce flies. Outdoor sprays work well to kill and repel flies, but may conflict with certain establishments such as restaurants.

Commercial kitchens and bars are aware that fruit flies love the smell and taste of beer. Beer spilled on floors should be mopped or rinsed off every night to prevent fruit fly infestations. The use of a commercial floor cleaner/sanitizer also helps. Fruit fly traps can be very effective at catching fruit flies and can be placed directly on bar tops and other food preparation surfaces where regular pesticides cannot be placed. Also, fly paper and glue strips are somewhat effective at capturing flies, but in most cases do not attract them and depend on an attractant of some sort or a shiny surface. Fly paper is messy and not very sanitary. For this reason, fly paper has traditionally not recommended for use in kitchens or other indoor sanitary areas.

There is still a need in the art for a sanitary, reliable method to reduce flies from entering a building that otherwise attracts flies. The present invention is directed to this objective.

### SUMMARY OF THE INVENTION

The present invention is an improved fly trap in the form of a sign that can attract and trap flies before they enter an establishment or once the flies are inside of an establishment. The invention uses an attractive element in the form of a plurality of LED lights, preferably blue LED lights, to coax flies to enter the sign. Adjacent the LED lights is a roller on which adhesive paper, or fly paper, is mounted. Flies that land on the fly paper are captured, and when the paper is full or need to be changed, the roller is actuated to present fresh fly paper. In this manner, all that need be touched is a handle or crank to rotate the fly paper on the roller, and the flies are collected in a place where they are not in view of patrons who may be turned off by the sight of the flies. These and other features of the invention may best be understood with reference to the Detailed Description of the Invention below, along with the accompanying figures of which the description is presented here.

### BRIEF DESCRIPTION OF THE DRAWINGS

FIG. 1 is a front view of a first preferred embodiment of the present invention;

FIG. 2 is a cross sectional bottom view of the embodiment of FIG. 1, taken along lines 2-2;

FIG. 3 is a front view of a second embodiment of the present invention;

FIG. 4 is a cross sectional bottom view of the embodiment of FIG. 3, taken along lines 4-4;

FIG. 5 is a cross sectional side view of the embodiment of FIG. 3, taken along lines 5-5; and

FIG. 6 is an elevated, perspective view of the fly paper roller and processor.

### DETAILED DESCRIPTION OF THE PREFERRED EMBODIMENTS

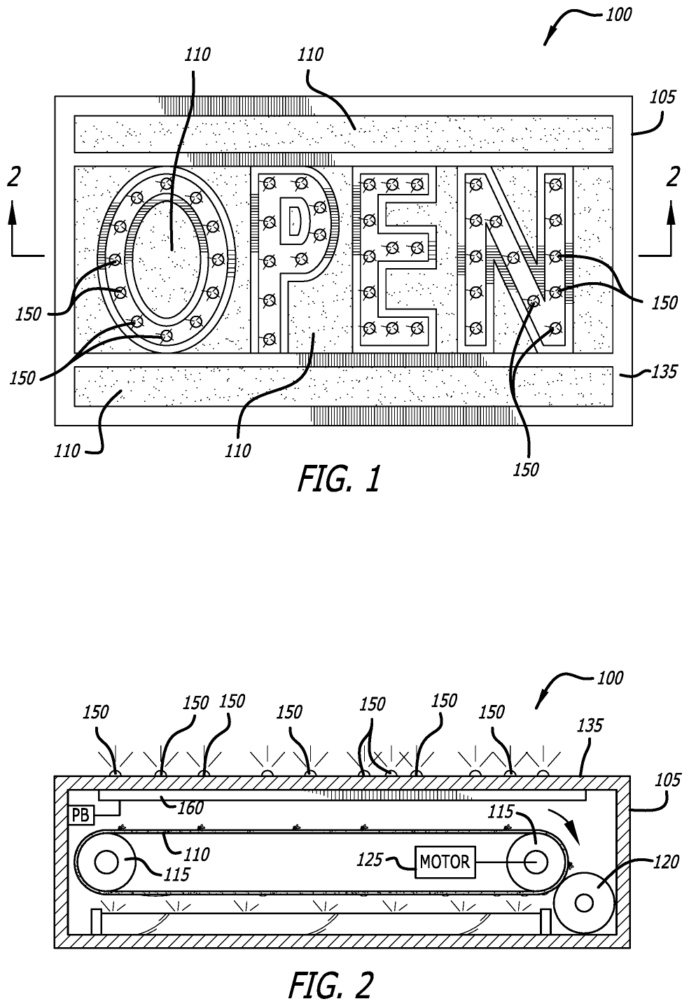

FIGS. 1 and 2 illustrate a first preferred embodiment of a fly trap in the form of a sign that can be hung over an entry way, in areas where flies tend to be present, or the like. The sign 100 comprises a housing 105 that supports a sheet 110 of fly paper, which preferably may be mounted on a pair of rollers 115 such that the fly paper can be taken off a roll 120 and continuously replenished when necessary with fresh fly paper. The roll 120 and the fly paper 110 can be advanced either by use of a motorized element 125 or a hand crank (not shown) so that a user does not need to touch the fly paper itself. In a preferred embodiment, the fly paper 110 can be advanced from outside the housing 105 either by the crank or using a button to actuate the motor and rotate the roller 115. As flies collect on a first surface of the fly paper, the fly paper is advanced along the rollers 115 to expose new fly paper, until the roll 120 is depleted.

The front panel 135 of the housing 105 preferably includes a plurality of LEDs 150 to attract the flies to the fly paper 110. The LEDs 150 may be mounted on a printed circuit board 160 that lights the LEDs, in either a constant or blinking pattern. In a preferred embodiment, the LEDs emit light in the blue wavelength spectrum to increase the attraction. This is because it has been discovered that insects are more highly attracted to UV light and blue light. These insects do not readily see light in the red wavelengths, which correspond with warmer colors. The LEDs 150 may be located on alphanumeric characters such as letters “O” “P” “E” “N” that serve as the function of the sign. The fly paper 110 is inside the housing 105 and adjacent the letters carrying the LEDs 150, such that flies will become attracted to the LEDs, enter the housing 105, and become trapped on the fly paper 110.

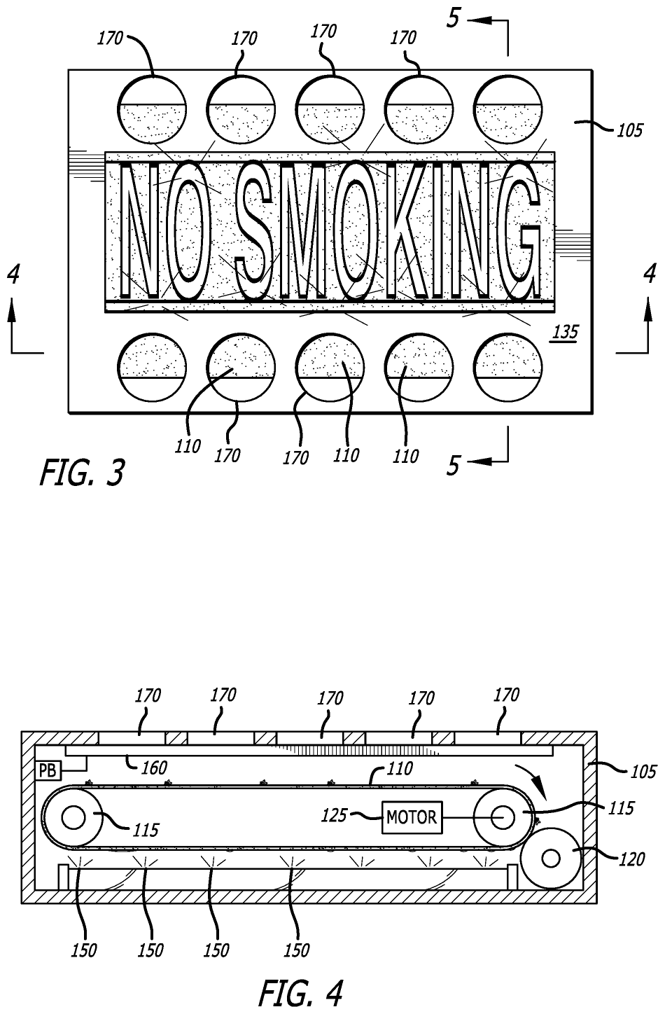

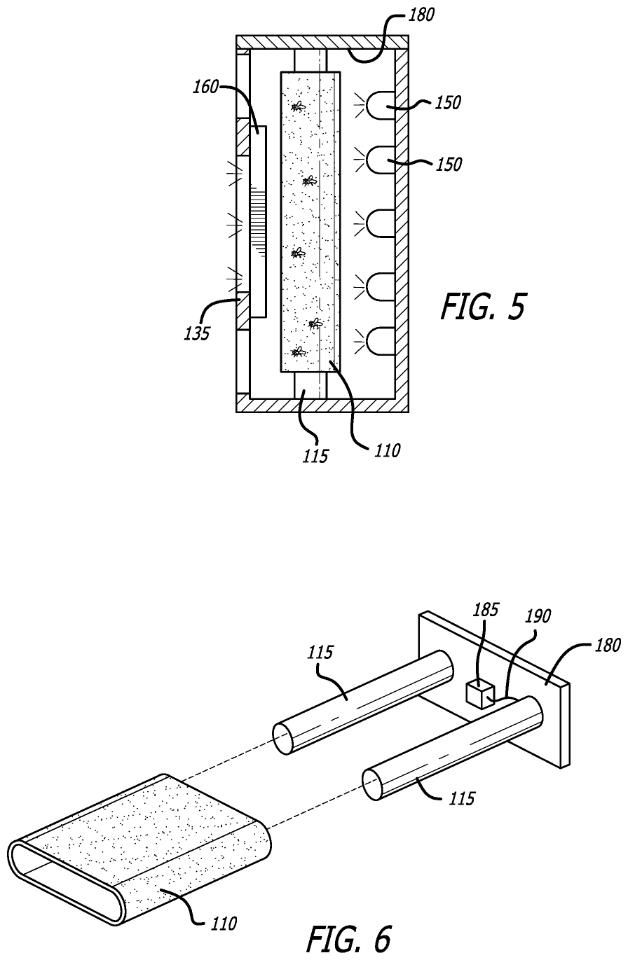

FIGS. 3-6 show an embodiment of the invention where the housing 105 of the present invention includes openings 170 in the front panel 135 that allows flies to come into contact with the roll of fly paper 110. The two rollers 115 are mounted on a side wall 180, and a controller 185 is linked via cable 190 to a motor that can be used to rotate one of the rollers 115 to scroll the fly paper 110.

The fly trap 100 of the present invention can be modified from the foregoing description and depictions without departing from the scope of the present invention. A person of ordinary skill in the art will readily appreciate that there are certain substitutions and modifications to the foregoing, and the scope of the invention is intended to include all such substitutions and modifications. Therefore, unless expressly specified, the invention is not to be limited to any figure or description, but rather the scope of the invention is measured by the appended claims using their customary and ordinary meanings.

1. A fly trap, comprising:
a housing having a front panel;
a scrolling sheet of fly paper located inside the housing;
a plurality of LEDs disposed on the front panel; and
openings on the front panel adjacent the LEDs to provide a path from outside the housing to the fly paper;
wherein the LEDs are disposed on alphanumeric characters that are disposed on the front panel.

2. The fly trap of claim 1, wherein the LEDs emit light having a wavelength in the blue spectrum.

3. The fly trap of claim 2, further comprising a motor adapted to scroll the sheet of fly paper.

4. The fly trap of claim 2, further comprising a supply roll in the housing and adapted to feed the scrolling sheet of fly paper.

5. (canceled)

6. The fly trap of claim 1, further comprising a circuit board to control an illumination of the LEDs.

7.-11.
